(19) United States
(12) Patent Application Publication
(10) Pub. No.: US 2022/0366431 A1
(43) Pub. Date: Nov. 17, 2022

(54) SYSTEM AND METHOD FOR ONBOARDING ACCOUNT CUSTOMERS

(71) Applicant: Zenus Bank International, Inc., San Juan, CA (US)

(72) Inventor: Gabriel Viera Rodriguez, San Juan, PR (US)

(73) Assignee: Zenus Bank International, Inc., San Juan, PR (US)

(21) Appl. No.: 17/724,165

(22) Filed: Apr. 19, 2022

Related U.S. Application Data
(60) Provisional application No. 63/188,994, filed on May 14, 2021.

(51) Int. Cl. G06Q 30/00; G06Q 40/02

(52) U.S. Cl. CPC G06Q 30/0185; G06Q 40/02

(57) ABSTRACT

A process that facilitates the real-time identification and verification of applicants across borders for account onboarding taking into consideration an assessment of legal, regulatory, financial, and reputational risks that gives rise to a comprehensive risk score formula.

### FIELD OF THE DISCLOSURE

The present invention relates generally to a process that facilitates the real-time identification and verification of applicants across borders for account onboarding taking into consideration an assessment of legal, regulatory, financial, and reputational risks that gives rise to a comprehensive risk score formula.

### BACKGROUND OF THE DISCLOSURE

Risk associated with the process of account onboarding or with accounts involved in cross-border transactions can be greatly increased due to the difficulty in gathering and accessing relevant data in real-time in order to mitigate the risk associated with the transaction. Known systems and methods help in ascertaining whether a name of a customer is associated with information that may be indicative of high risk; however, there is no method or system to tie such information to a comprehensive risk score formula and real-time identification and verification procedures.

### SUMMARY OF THE DISCLOSURE

The disclosure relates to a process that facilitates the real-time identification and verification of applicants across borders for account onboarding taking into consideration an assessment of legal, regulatory, financial, and reputational risks that gives rise to a comprehensive risk score formula. The risk score leverages personal information, location, transaction purpose, transaction routing intent, regulatory questions, as well as biometrics with voice, face and fingerprint at the time of onboarding through a smart phone mobile app.

In particular, the disclosure involves a workflow and unique customer risk score that would allow a U.S. bank with a domestic and international banking license to digitally and/or remotely onboard customers and operate “cross-border” while domiciled in the U.S. The process requires collecting information about an account applicant and calculating a risk based on the interpretation of the bank's obligations to comply with the U.S. Patriot Act, Bank Secrecy Act (“BSA”) and the Office of Foreign Asset Control (“OFAC”).

The process also integrates API-driven and cloud-based technology to enable a bank to provide the following services in real-time:
real-time cross-border retail, commercial, and correspondent account onboarding leveraging mobile, web and regulatory technologies to comply with U.S. Patriot Act, BSA, and OFAC requirements.
real-time monitoring using risk score on transactions following the BSA travel rules.
real-time BSA enterprise risk assessment by collecting all required data.

### BRIEF DESCRIPTION OF THE DRAWINGS

FIG. 1 is a work flow diagram of a retail account onboarding process.

FIG. 2 shows the main stages of the retail account onboarding process.

FIG. 3 shows the risk rating and weight percentage of various risk indicators considered for the retail account onboarding process.

FIG. 4 is a work flow diagram of a commercial account onboarding process.

FIG. 5 is another work flow diagram of a commercial account onboarding process.

FIG. 6 shows the main stages of the commercial account onboarding process.

FIG. 7 shows the risk rating and weight percentage of risk indicators considered for the commercial account onboarding process.

FIG. 8 shows the interface available to a user once the account has been approved.

### DETAILED DESCRIPTION OF THE DISCLOSURE

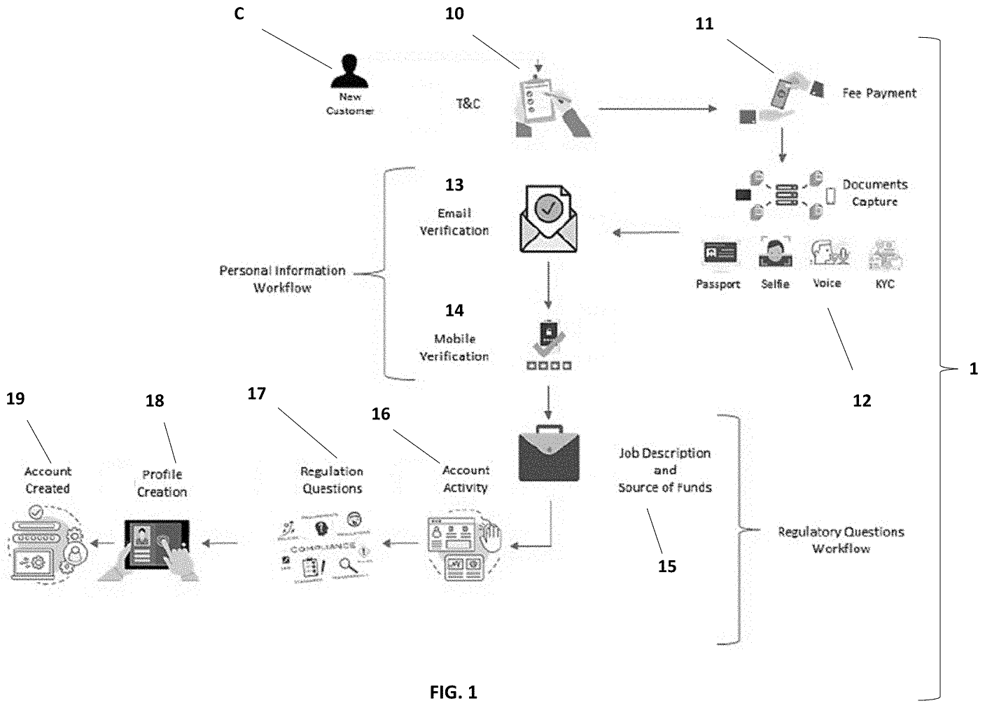

FIG. 1 shows a work flow diagram of an account onboarding process or method 1 for retail accounts, that is performed by a computer. The computer includes a non-transitory memory that comprises program instructions stored thereon, which when executed by a processor cause the computer to perform the process for account onboarding described herein. The steps may be executed in a mobile application or a website.

As a first step of the account onboarding method 1, the location of the user or customer C is determined (via GPS) along with the IP address of the device being used to execute the account onboarding method 1. If the customer is located in a high risk country (as defined or determined by financial or regulatory entities), or using a VPN or a proxy, the onboarding process stops, and the customer is denied access to the account. Next, the user or customer C is prompted, on the display screen of a mobile device, to accept the terms and conditions 10 of the financial institution conducting the account onboarding process. In this step the customer indicates, for example, whether it is over 18 years old; or whether it desires to receive marketing campaigns. Next, the customer is prompted to make payment 11 of the fee required to be part of the retail account onboarding process. In this step, the customer is required to provide a credit card number, a cardholder name, the expiration date on the credit card, the security code on the credit card, and the email address from the owner of the online banking account. Payment may be processed through any known e-payment method. The next step involves an identity verification step involving a personal information and document collection stage 12. Particularly, the customer is prompted to provide a valid government-issued identification (e.g., passport); submit a self-portrait photograph; and to record his or her voice. The device used by the customer to execute the account onboarding process or method 1, must include a camera and a microphone in order for the customer to be able to submit these documents or information. During document collection stage 12, an application programming interface (“API”) collects or extracts data from the passport for verification, including the passport number, name and last name of the customer, date of birth of the customer, the passport expiration date, and the passport's MRZ code. This information is extracted to verify the authenticity of the passport and the identity of the customer. Moreover, the API creates a token for face biometrics validation of a specific customer; and is responsible for a tokenized version of the customer's voice and/or face. The personal information collected during step 12 incudes, for example, the customer's name, address, gender, status, education level, and date of birth. It should be noted that as information is being submitted by the customer, said information is being stored in the back-end of the application the onboarding method is being executed on.

The next step of the onboarding method 1 involves a first verification step 13 in which the customer is prompted to verify his or her email address. The verification step 13 is done via an application programming interface. After email verification, the account onboarding method 1 involves a second verification step 14, which prompts the customer to verify his or her mobile device. The second verification step 14 is also done via an application programming interface. The first and second verification steps are then followed by a job description step 15, in which the customer is prompted to provide his or her job description via job description questions in which the customer must indicate the source of his or her source of funds or assets. Job description step 15 helps in detecting, preventing, and investigating money laundering, fraud, and compliance violations. During job description step 15 the customer must provide data such as: the customer's occupation, starting date, employer name (if any), industry, country, address, source of funds, monthly income, annual bonus, any other source of income.

Next, the retail account onboarding method 1 involves an account activity step 16, in which the customer provides answers to questions regarding the expected account activity (i.e., the uses that will be given to the account). In account activity step 16, the customer indicates the type of service it will be using; whether it will involve foreign exchange, or ACH transfer services, or a wire transfer services, or peer to peer services, or debit card services. Also, the customer must indicate how many currencies it is expected to use; and the purpose of the account, that is, whether it relates to income and living expenses or whether it relates to investing activity. Lastly, in step 16, the customer must indicate the countries in which it expects to have transactions with; the number of cross-border deposits it expects to receive per month; and the expected amount of payments per month.

The account activity step 16 is followed by a regulatory question 17 step in which the customer is prompted to provide answers to questions which determine if the customer is in compliance with financial laws, rules and regulations. At the completion of these steps, a customer profile 18 is created. Upon creation of the profile 18, a customer account 19 is created.

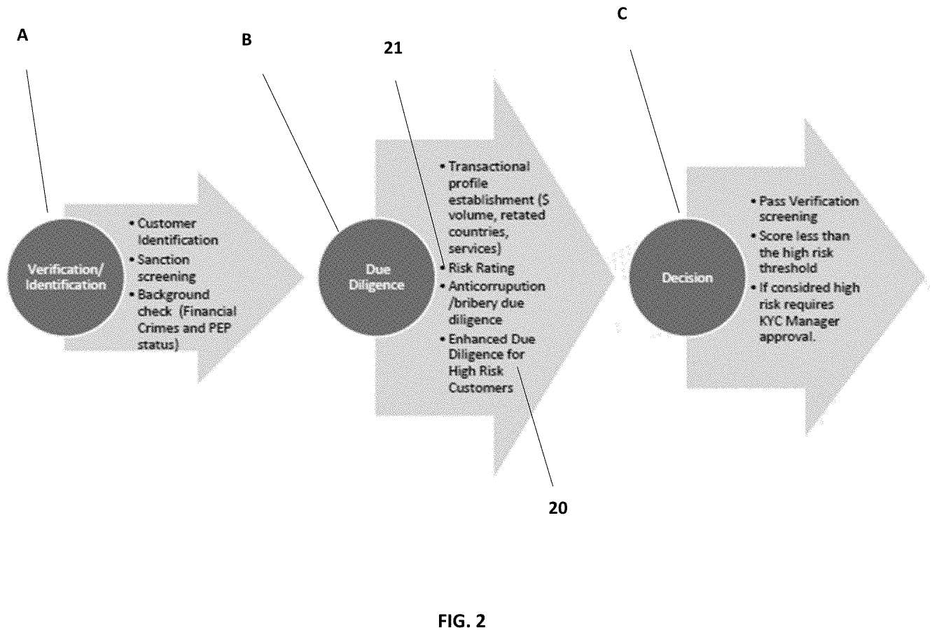

The work flow of a retail account onboarding process or method 1 can be subdivided in three main stages as shown in FIG. 2. Particularly, the work flow includes a verification/identification stage A; a due diligence stage B; and a decision-making stage C. During the verification/identification stage A, the customer is prompted to submit the information required by section 326 of the Patriot Act. The US Patriot Act in its efforts to prevent and identify financial crimes and terrorism financing mandates financial institutions to collect information that identifies all persons that seek to establish a relationship with a financial institution. This means that the customer must provide its name, physical address, date of birth and identification documents. The information submitted by the customer during the verification/identification stage A, will be verified via a screening and background check of the submitted information with preexisting lists or data bases of politically exposed individuals or heightened risk individuals and organizations, such as those provided by Lexis Nexis, World-check, etc. If the customer information matches that of one individual on the preexisting lists or data bases of heightened risk individuals and organizations, an alert will be triggered. If there is no match, the verification/identification stage A is continued.

As the verification/identification stage A continues, the customer is prompted to indicate its source of funds or wealth. Depending on the source, the customer will be awarded a score based on the risk of fraud involved in the source of the funds or wealth. The higher the risk of fraud involved in the source of wealth, the higher the score and vice versa. For example, if the source of funds has a low risk of fraud, such as the customer's payroll or government assistance, the customer is awarded a score of 1. Conversely, if the source of the funds is one in which there is a high risk of fraud, such as trusts or investments, then the customer would be awarded a score of 5. Lastly, if the source of funds has a moderate risk of fraud, such as during self-employment, the customer is awarded a score of 3.

During the verification/identification stage A, the customer is also prompted to indicate its occupation. Depending on the risk of fraud involved with the indicated occupation, the customer will be awarded a score. The higher the risk of fraud involved in the occupation in question, the higher the score and vice versa. For example, if the occupation is one in which the risk of generating wealth fraudulently is low, such as teachers, scientists, artists, etc., the customer is awarded a score of 1. Conversely, if the occupation is one in which there is a high risk of generating wealth fraudulently, such as real estate brokers, accountants, security brokers, sailors, arts dealers, etc., then the customer would be awarded a score of 5. Lastly, if the occupation is one in which the risk of generating wealth fraudulently is moderate, such as bankers, then the customer is awarded a score of 3. Once the verification/identification stage A is completed, the method enters the due diligence stage B.

During the diligence stage B, the customer is prompted to respond to questions concerning financial background information, account expected activity, control of the account, and to provide the information required by section 326 of the U.S. Patriot Act. The customer will also be prompted to indicate the purpose of the account; name the countries to which the funds will be sent to; name the countries from which the funds will come from; indicate the amount of incoming/outgoing international wires or the volume of incoming/outgoing activity; indicate the monthly income, the source of income, an indicate how many currencies the customer will utilize (collectively, the “Financial Activity”). It must be noted that answers provided by the customer pursuant to section 326 of the U.S. Patriot Act, will determine if the customer is rejected or if the account onboarding process 1 is continued.

During this stage, an enhanced due diligence module 20 is employed to determine the risk involved with the customer in question. The enhanced due diligence module 20 performs a screening or background check (of the information provided by the customer during the verification/identification stage A and diligence stage B) with the OFAC database to verify whether the customer in question is a specially designated national (“SDN”) or if it falls under a zero-tolerance threshold. If the customer is an SDN or falls under the zero-tolerance threshold, the customer is disqualified. Depending on the risk of fraud involved with the Financial Activity for which the customer provided the information, the customer will be awarded a score. Low risk activities will be awarded 1-2 points; moderate activities will be awarded 3-5 points; and high-risk activities will be awarded 6 or more points. If the activity involves an amount or volume of money, then an amount or volume of less than or equal to $10,000 will be considered as a low risk; amount sin the range of $10,001 to $15,000 will be considered as a moderate risk; and amounts of more than $15,001 will be considered as a high risk. Once the due diligence stage B is completed the method enters the decision-making stage C.

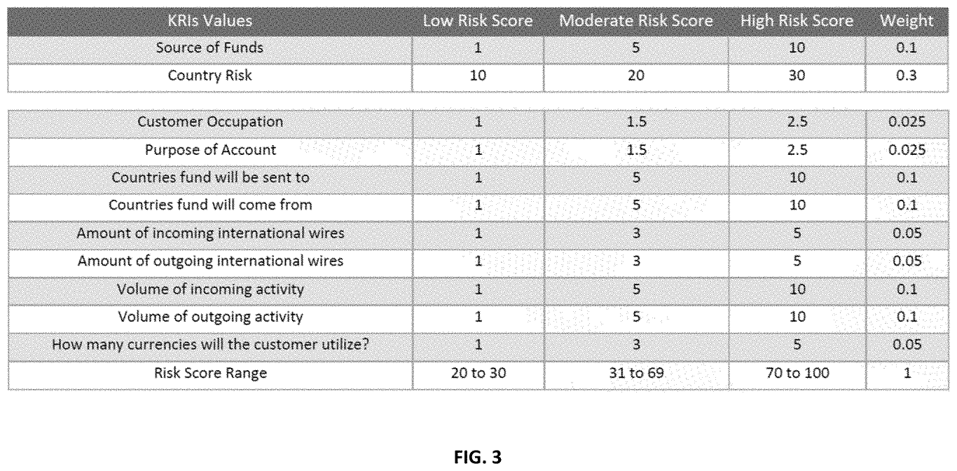

During the decision-making stage C, a customer onboarding risk rating module 21 is employed to add the risk scores issued during the verification/identification and due diligence stages, based on the responses submitted by the customer. The customer onboarding risk rating module 21 considers various key risk indicators, as shown in FIG. 3, that are calculated while the customers responds to due diligence and enhanced due diligence questions. As also shown in FIG. 3, each risk indicator is assigned a weight percentage.

Moreover, as shown in FIG. 3, if the sum of risk scores is less or equal to 30, the risk is considered low. If the sum of risk scores is between 31 and 69, the risk is considered moderate. If the sum of risk scores is equal to 70 or higher, the risk is considered high. Whether an account will be approved will depend on the level of risk of the customer and on whether the information provided by the customer matches with the information on the OFAC database or another similar list. If there is a match with the information on the OFAC database, the account will not be approved, and further compliance review or manager approval will be required. If there is no match with the information on the OFAC database, the account will be approved for low risk and moderate customers, while high risk customers would require further compliance review or manager approval. If there is no match with the information on the OFAC database, but there is a match on another list or database that contains information of individuals or companies associated with fraud, the account will be approved for low-risk customers only. Moderate and high-risk customers would need additional compliance review or manager approval in this last scenario.

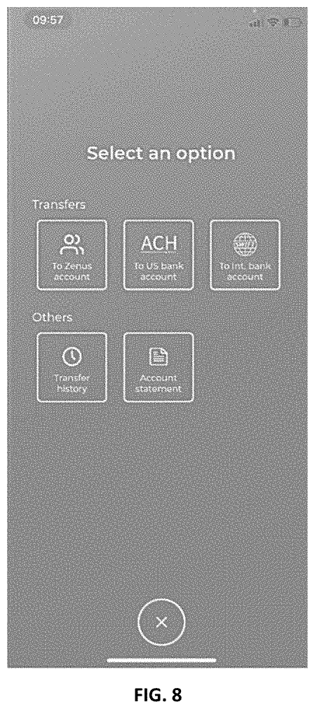

Once the account has been approved, the user will have certain benefits. Particularly the user can make transaction, such as money transfers, more easily between banks. As shown in FIG. 8, an interface is provided that facilitates transaction once the account has been approved. For example, the user may make transfers to his account, or to an ACH account, or to an international bank account. The interface also provides helpful information such as transaction history and bank account statements.

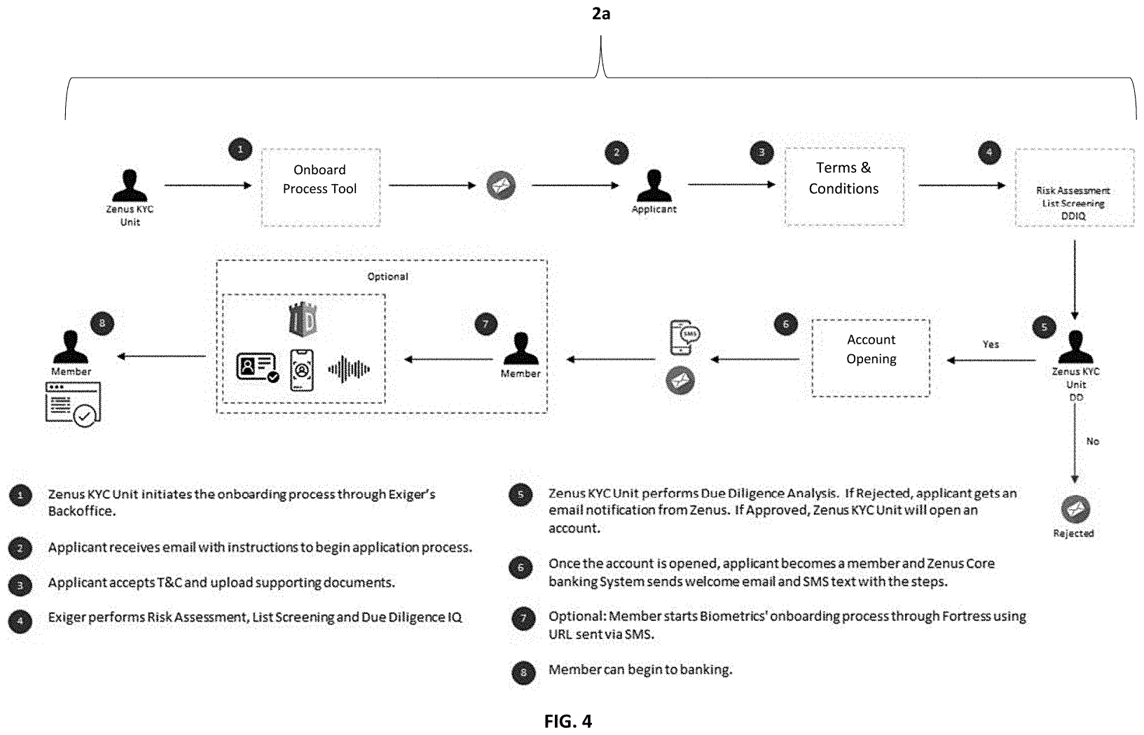

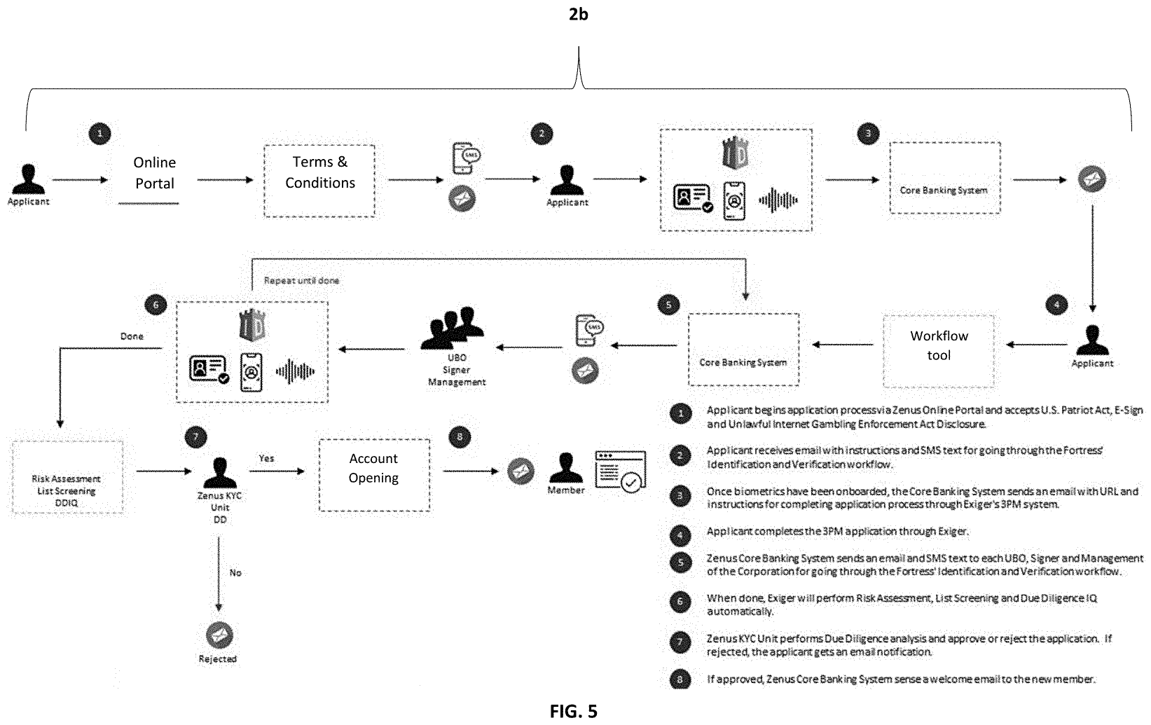

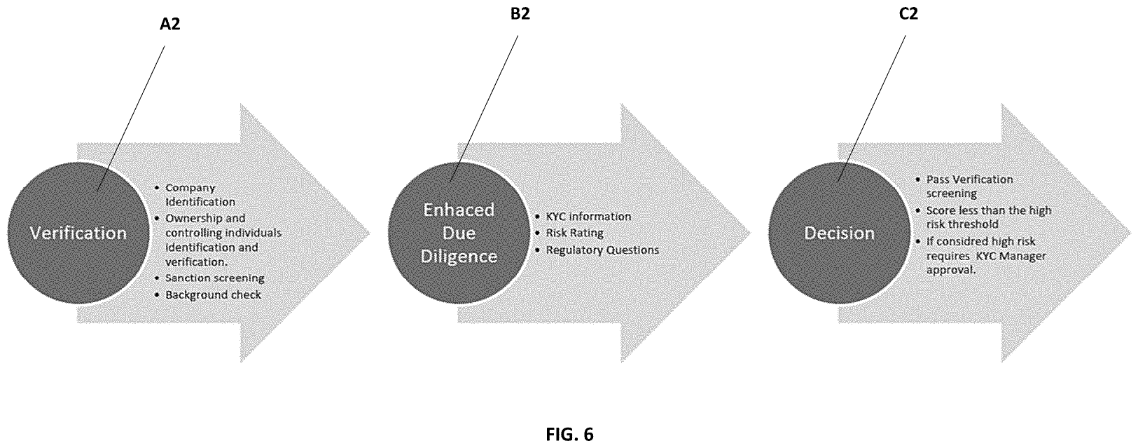

The disclosure also contemplates an account onboarding process or method 2a, 2b, to be used for commercial accounts, as shown in FIGS. 4 and 5. The commercial account onboarding process or method 2a, 2b, can be used to identify the ultimate beneficiary owner and controller of the commercial account. To achieve this goal, the work flow of a commercial account onboarding process or method 2a, 2b is subdivided into three main stages, as shown in FIG. 6. Particularly, the work flow includes a verification/identification stage A2; a due diligence stage B2; and a decision-making stage C2. During the verification/identification stage A2, the customer, which in the onboarding method 2a, 2b is a company, is prompted to submit the information required by section 326 of the Patriot Act. The US Patriot Act in its efforts to prevent and identify financial crimes and terrorism financing mandates financial institutions to collect information that identifies all persons that seek to establish a commercial account banking relationship. This means that the customer must provide the company identification documents, company name, company registration number, country in which the company was organized, location of principal place of business, mailing address, physical address, contact information, type of entity, and classification under the North American Industry Classification System (NAICS) (collectively, “Company ID Information”).

The information submitted (e.g., the Company ID Information) by the customer during the verification/identification stage A2, will be verified via a screening and background check of the submitted information with preexisting lists or data bases of politically exposed individuals or heightened risk individuals and organizations, such as those provided by Lexis Nexis, World-check, etc. If the customer information matches that of one individual on the preexisting lists or data bases of heightened risk individuals and organizations, an alert will be triggered. If there is no match, the verification/identification stage A2 is continued. The level of risk accorded to the company, with respect to the Company ID Information, will depend primarily on the type of entity that the customer (i.e., the company) is. If the customer is a non-bank financial institution business provider, then it will be considered a high risk business; if it is a foreign business entity, the risk will be considered moderate; and if it is a corporate account, then the risk will be considered low.

To be able to get a full picture of the company's profile, projections and business plan, the customer in the account onboarding process or method 2a, 2b must also provide the following financial background information: date of the last closing year, annual total sales, company total assets, company total liabilities, company net worth, total operational costs, company total employees, and origin of funds (collectively, “Financial Background Information”). The level of risk accorded to the company, with respect to the Financial Background Information, will depend primarily on the company net worth origin of the funds. If the company net worth is less than $500,000.00, the risk will be considered low; if it is between $500,001.00 and $2,500,000.00, the risk will be considered moderate; and if is $2,500,001.00 or higher, the risk will be considered high. Similarly, if the origin of funds comes from a holding company capital infusion, or from equity capital contribution, or from a loan from a banking institution, the risk will be considered low; if it comes from the infusion of capital by account at another bank, the risk will be considered moderate; and if it comes from a sister company capital infusion, the risk will be considered high.

In order to establish the account risk profile, the customer in the account onboarding process or method 2a, 2b must also provide the expected account activity. Particularly, the customer must provide, the purpose of the account, the country the funds will be sent to, the country the funds come from, the services required (e.g., international wires or debit cards), the amount of incoming/outgoing international wires, and the volume of incoming/outgoing activity (collectively, the Expected Account Activity). The level of risk accorded to the company, with respect to the expected account activity, will depend primarily on the purpose of the account, the amount of incoming/outgoing international wires, and the amount of incoming/outgoing activity. If the purpose of the account is to cover operational expenses, the risk will be considered low; whereas if the purpose is related to investment and private portfolio management, the risk will be high. Similarly, if the amount of incoming/outgoing international wires is between 1-5, risk will be considered low; if it is between 6-10 it will be considered moderate; and if it is 11 or higher, the risk will be considered high. Moreover, if the amount of incoming/outgoing activity is less than or equal to $30,000.00, the risk will be considered low; if the amount is between $30,001.00 and $100,000.00, the risk will be considered moderate; and if it is $100,000.00 or higher, the risk will be considered high. Once the verification/identification stage A2 is completed, the method enters the due diligence stage B2.

During the diligence stage B2, the customer is prompted to identify the individuals that control the account, the legal representative of the account, and the signer of the account. Specifically, the customer must identify the name and last name of the person/company controlling the account, its identifying number (e.g., tax ID or passport number), date of birth, address, and to provide biometrics (e.g., finger print or retina scan). The same information must be provided for the legal representative and for the signer. As part of the diligence stage B2, the customer must also provide answers to certain regulatory questions required under section 326 of the U.S. Patriot Act, the Fair and Accurate Credit Transactions Act (“FACTA”), and the Unlawful Internet Gambling Enforcement Act of 2006 (“UIGEA”). FACTA, for example, requires indicating if the company is located in the United States; if any of the shareholder that are natural persons are American citizens; and if any of the shareholder are a holding company incorporated in the United States. The U.S. Patriot Act, on the other hand, requires indicating if any member of the board of director, executive or shareholder of the company is a senior foreign political figure in the legislative, administrative, military or judicial branches of a foreign government; if any member of the board of directors, executive or shareholder of the company is a senior foreign political figure in the legislative, administrative, military or judicial branches of a foreign government; if any member of the board of directors, executive or shareholder of the company is a senior member of a foreign political party; and if any member of the board of director, executive or shareholder of the company is a senior executive of a foreign government-owned commercial enterprise. Lastly, the UIGEA requires indicating if the user will be participating in Internet gambling.

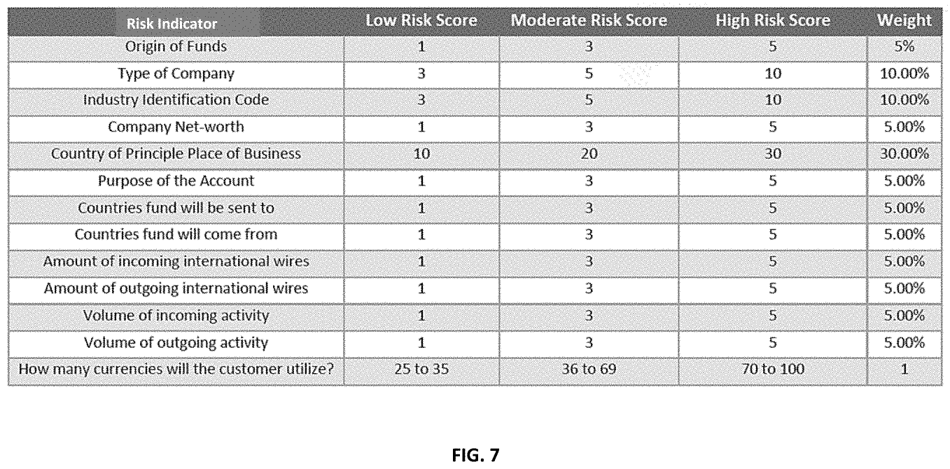

As a last part of the diligence stage B2, the customer in the account onboarding process or method 2a, 2b takes into consideration thirteen (13) key risk indicators, shown in FIG. 7, that are calculated while the customers responds to due diligence questions. FIG. 7 shows the risk rating and weight of each indicator. The risk indicators include: the origin of the funds, the type of company, the industry identification code, company net worth, purpose of the account, services risk (e.g., international wires, debit cards, etc.), country funds will be sent to, country funds will come from, amount of incoming wires, amount of outgoing wires, amount of incoming activity, amount of outgoing activity, and indicating how many currencies the customer will utilize. If the sum of risk scores falls in the range of 25 to 35, the customer will be awarded a low risk score. If the sum of risk scores falls in the range of 36 to 69, the customer will be awarded a moderate risk score. If the sum of risk scores falls in the range of 70 to 100, the customer will be awarded a high risk score.

During the decision-making stage C2, a customer onboarding risk rating module 21 is employed to add the risk scores issued during the verification/identification and due diligence stages, based on the responses submitted by the customer. The customer onboarding risk rating module 21 considers various key risk indicators, as shown in FIG. 3, that are calculated while the customers responds to due diligence and enhanced due diligence questions. As also shown in FIG. 3, each risk indicator is assigned a weight percentage.

Whether an account will be approved will depend on the level of risk of the customer and on whether the information provided by the customer matches with the information on the OFAC database or another similar list. If there is a match with the information on the OFAC database, the account will not be approved, and further compliance review or manager approval will be required. If there is no match with the information on the OFAC database, the account will be approved for low risk and moderate customers, while high risk customers would require further compliance review or manager approval. If there is no match with the information on the OFAC database, but there is a match on another list or database that contains information of individuals or companies associated with fraud, the account will be approved for low-risk customers only. Moderate and high-risk customers would need additional compliance review or manager approval in this last scenario.

It should be noted that the onboarding methods 1 and 2a, 2b also contemplate a step of collection of signatures and biometrics. During the different stages the customer may be prompted to submit his or her signature electronically and/or to submit a retina scan, voice or his or hers fingerprints to verify the identity of the customer. For example, during document collection stage 12, the customer is prompted to provide the signatures and/or biometrics.

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means plus function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

What is claimed is:

1. A method for reducing the risk of fraud in a bank account onboarding process, said method being performed in a computer having a non-transitory memory that comprises program instructions stored thereon that, when executed by a processor, cause the computer to perform the following steps:
prompt a user to accept terms and conditions from a financial institution conducting the account onboarding method;
prompt the user to provide payment information;
prompt the user to submit identity verification documents, said identity verification documents comprising a government-issued identification, a self-portrait photograph, and a recording of the user's voice;
collect or extract, via an application programming interface (API), data from the government-issued identification;
wherein the API creates a token for face biometrics validation of the user and a tokenized version of the user's voice;
prompt the user, via a first verification step comprising an API, to verify an email address;
prompt the user, via a second verification step comprising an API, to verify a mobile device;
prompt the user to provide information required by at least one of the financial laws of the United States;
verify the information required by the at least one of the financial laws of the United States submitted by the user by comparing the submitted information with preexisting lists or data bases of politically exposed or heightened risk individuals and organizations;
wherein if the information submitted by the user matches that of one individual on the preexisting lists or data bases of politically exposed or heightened risk individuals and organizations, an alert will be triggered;
wherein if there is no match, the user is prompted to indicate its occupation and its source of funds or wealth;
wherein the user is awarded a score based on the risk of fraud involved in the occupation or source of the funds or wealth;
wherein if the occupation or source of the funds or wealth has a low risk of fraud, the user is awarded a low risk score;
wherein if the occupation or source of the funds or wealth has a high risk of fraud, the user is awarded a high risk score;
wherein if the occupation or source of the funds or wealth has a moderate risk of fraud, the user is awarded a moderate risk score;
wherein the basis for whether the risk of fraud involved in the occupation or source of funds is high, low, or moderate, is based on previously stored risk indicators on the memory regarding occupations or sources of the funds or wealth considered to have a high, low, or moderate risk of fraud;
prompt the user to provide responses to questions concerning its financial background information, account expected activity, and control of the account (collectively, “Financial Activity”);
determine the risk involved with the user by performing a screening or background check with a database that contains information of individuals or companies associated with fraud, in order to verify whether the user is a specially designated national or if it falls under a zero-tolerance threshold;
wherein if the user is a specially designated national or falls under the zero-tolerance threshold, the user is disqualified;
wherein the user is awarded a score based on the risk of fraud involved in the Financial Activity;
wherein if the Financial Activity has a low risk of fraud, the user is awarded a low risk score;
wherein if the Financial Activity has a high risk of fraud, the user is awarded a high risk score;
wherein if the Financial Activity has a moderate risk of fraud, the user is awarded a moderate risk score;
wherein the basis for determining whether the risk of fraud involved in the Financial Activity is high, low, or moderate, is based on previously stored risk indicators on the memory regarding activities considered to have a high, low, or moderate risk of fraud;
add the sum of the risk scores awarded to the user; and
create a user profile and account based on the risk scores and information provided by the user.

2. The method of claim 1, further comprising the following steps:
determine a location and an IP address of a user;
wherein if the user is located in a country with a high risk of fraud, or using a VPN or a proxy, then the user is denied access to the bank account; and
wherein the basis for whether a country has a high risk of fraud is based on previously stored risk indicators on the memory regarding countries considered to have a high risk of fraud.

3. The method of claim 1, wherein the information required by the financial laws of the United States includes the information required under the U.S. Patriot Act, including at least one of the user's name, last name, physical address, date of birth, nationality, level of education.

4. The method of claim 1, wherein the questions concerning the user's financial background information, account expected activity, and control of the account include: indicating purpose of the account, name of the country or countries funds will be sent to, name of the country or countries funds will come from, the amount of incoming or outgoing international wires, the volume of incoming or outgoing activity, the monthly income, the source of income, and how many currencies the user will utilize.

5. The method of claim 1, wherein each risk indicator is assigned a weight percentage.

6. The method of claim 1, wherein if the sum of risk scores has a value less or equal to 30, the risk is considered low, if the sum of risk scores has a value between 31 and 69, the risk is considered moderate, and if the sum of risk scores has a value equal to 70 or higher, the risk is considered high.

7. The method of claim 1, wherein approval of the account depends on the sum of risk score awarded to the user and on whether the information provided by the user matches with the information on the database that contains information of individuals or companies associated with fraud.

8. The method of claim 7, wherein if there is a match with the information on the database, the account will not be approved, and further compliance review or manager approval will be required.

9. The method of claim 7, wherein if there is no match with the information on the database, the account will be approved for a user having a low or moderate risk score, whereas a user having a high risk score would require further compliance review or manager approval.

10. The method of claim 7, wherein if there is no match with the information on the database bur there is a match on a second database that contains information of individuals or companies associated with fraud, the account will be approved for a user having a low risk score, whereas a user having a moderate or high risk score would require further compliance review or manager approval.

11. A bank account onboarding method, said method being performed in a computer having a non-transitory memory that comprises program instructions stored thereon that, when executed by a processor, cause the computer to perform the following steps:
prompt a user to provide information required by at least one of the financial laws of the United States, including at least one of: company identification documents, company name, company registration number, country in which the company was organized, location of principal place of business, mailing address, physical address, contact information, or type of entity (collectively “Company ID Information”);
prompt the user to provide at least one of the following financial background information: date of the last closing year, annual total sales, company total assets, company total liabilities, company net worth, total operational costs, company total employees, and origin of funds (collectively, “Financial Background Information”);
prompt the user to provide at least one of the following expected account activity: purpose of the account, the country the funds will be sent to, the country the funds come from, the services required, the amount of incoming/outgoing international wires, and the volume of incoming/outgoing activity (collectively, the Expected Account Activity);
prompt the user to identify the individual that controls the account, the legal representative of the account, and the signer of the account;
prompt the user to provide answers to regulatory questions required under the financial laws of the United States;
verify the Company ID Information submitted by the user by comparing the submitted information with preexisting lists or data bases of politically exposed or heightened risk individuals and organizations;
wherein if the Company ID Information submitted by the user matches that of one individual on the preexisting lists or data bases of politically exposed or heightened risk individuals and organizations, an alert will be triggered;
determine the risk involved with the user based on the Company ID Information, the Financial Background Information, and the Expected Account Activity;
wherein the user is awarded a score based on the risk of fraud involved in the Company ID Information, the Financial Background Information and Expected Account Activity;
wherein if the Company ID Information, the Financial Background Information and the Expected Account Activity have a low risk of fraud, the user is awarded a low risk score;
wherein if the Company ID Information, the Financial Background Information and the Expected Account Activity have a high risk of fraud, the user is awarded a high risk score;
wherein if the Company ID Information, the Financial Background Information and the Expected Account Activity have a moderate risk of fraud, the user is awarded a moderate risk score;
wherein the basis for determining whether the risk of fraud involved in t the Company ID Information, he Financial Background Information and the Expected Account Activity have is high, low, or moderate, is based on previously stored risk indicators on the memory regarding activities considered to have a high, low, or moderate risk of fraud;
add the sum of the risk scores awarded to the user; and
create a user profile and account based on the risk scores and information provided by the user.

12. The method of claim 11, wherein if the Financial Background Information indicates that the company net worth is less than $500,000.00, the risk will be considered low.
wherein if the Financial Background Information indicates that the company net worth is between $500,001.00 and $2,500,000.00, the risk will be considered moderate; and
wherein if the Financial Background Information indicates that the company net worth is $2,500,001.00 or higher, the risk will be considered high.

13. The method of claim 11, wherein if the Financial Background Information indicates that the origin of funds comes from a holding company capital infusion, or from equity capital contribution, or from a loan from a banking institution, the risk will be considered low;
wherein if the Financial Background Information comes from the infusion of capital by account at another bank, the risk will be considered moderate; and
wherein if the Financial Background Information comes from a sister company capital infusion, the risk will be considered high.

14. The method of claim 11, wherein if the purpose of the Expected Account Activity is to cover operational expenses, the risk will be considered low; and
Wherein if the purpose of the Expected Account Activity is related to investment and private portfolio management, the risk will be high.

15. The method of claim 11, wherein if the amount of incoming/outgoing international wires is between 1-5, risk will be considered low;
wherein if the amount of incoming/outgoing international wires is between 6-10 it will be considered moderate; and
wherein if the amount of incoming/outgoing international wires is 11 or higher, the risk will be considered high.

16. The method of claim 11, wherein if the amount of incoming/outgoing activity is less than or equal to $30,000.00, risk will be considered low;
wherein if the amount of incoming/outgoing activity is between $30,001.00 and $100,000.00, the risk will be considered moderate; and
wherein if the amount of incoming/outgoing activity is $100,000.00 or higher, the risk will be considered high.
